(19) United States
(12) Patent Application Publication
(10) Pub. No.: US 2009/0068324 A1
(43) Pub. Date: Mar. 12, 2009

(54) Confection holder

(76) Inventor: Sergio Sandoval, Oak Lawn, IL (US)

Correspondence Address: McKenna McGovern Burkhart, 134 North LaSalle Street, Suite 2040, CHICAGO, IL, 60602, US

(21) Appl. No.: 11/899,457

(22) Filed: Sep. 6, 2007

(51) Int. Cl. A23L 1/00

(52) U.S. Cl. 426/134

(57) ABSTRACT

A frozen confection holding apparatus for use with frozen confections having either flat sticks or cylindrical sticks. The frozen confection holding apparatus includes an aperture assembly adapted and constructed to alternatively receive a flat stick of a frozen confection and a cylindrical stick of a frozen confection. A cylindrical gripping surface has an outer diameter slightly less than an inner diameter of a standard push-pop tube. In an embodiment, the frozen confection holding apparatus includes a first aperture having an inner volume conforming to the shape of a flat stick of a frozen confection, and a second aperture having an inner volume conforming to the shape of a cylindrical stick of a frozen confection. The frozen confection holder is movable between a first orientation in which the first aperture receives a flat stick of a frozen confection, and a second orientation in which the second aperture receives a cylindrical stick of a frozen confection.

### CROSS-REFERENCE TO RELATED APPLICATIONS

None

### STATEMENT AS TO RIGHTS TO INVENTIONS MADE UNDER FEDERALLY-SPONSORED RESEARCH AND DEVELOPMENT

None

### FIELD OF THE INVENTION

The present invention relates generally to frozen confections, and specifically to holders adaptable for use with a variety of frozen confections.

### DESCRIPTION OF RELATED ART

The frozen pop has its origins in frozen desserts that are as old as civilization. The ancient Romans had blocks of ice carried down from the mountains in the summer. The blocks were ground into crushed ice that was flavored with fruit and syrup. The Chinese are credited with the same practice, and these sherbets, sorbets, and frozen ices were served in the thirteenth century court of Kublai Khan (1215-1294) when the Italian adventurer Marco Polo (1254-1324) visited. Other ancient cultures including those of Turkey, Persia (now Iran), the Arabian Peninsula, and India also knew of frozen, flavored ices. They were usually a privilege of the wealthy and were made of ice, fruit pulp, fruit syrup, and flowers for flavor, fragrance, and color. Frozen treats were served to honor guests at banquets or to cleanse the palate between courses, as sorbets are still used today.

The invention of the frozen pop is attributed to Frank Epperson, who in 1905, as an 11-year-old, mixed powdered soda pop and water to create a drink, as was popular at the time. Epperson forgot about his preparation and left it outside on the porch of his home in Oakland, Calif. Due to an unexpected cold spell, the concoction froze overnight, and the stick he had used to stir the powder in the water stuck in the frozen liquid. Frank pulled out the whole frozen mass and found that he had invented a new treat. He named it the “Epperson icicle.” The following summer, he made his frozen treats in his family's icebox and sold them around his neighborhood under the shortened name of “Epsicle.” Frank again rechristened his discovery the “popsicle” to show that they were made from soda pop.

Another popular frozen confection is sold in the form of a cylindrical paper tube filled with frozen sherbet or similar substance. One of the more widely available brands of such confections is the nearly ubiquitous the “push-up”®. A cylindrical plug in the bottom of the tube is attached to a stick, which is used both as a handle and to push the sherbet above the tube for consumption.

Although both popsicles® and push-ups® are provided with integral handles, the art has developed several forms of auxiliary grips for such confections. For example, U.S. Pat. No. 5,993,870 to Hoeting deals with a holder and coating device for use with handle-mounted confectionery products such as lollipops, or ice cream treats or the like. The confectionery holder holds and stores both a handle-mounted confectionery product and an edible topping of a particulate material, and facilitates coating the confectionery product with the topping. The holder has a base and a removable cover for gaining access to the confectionery product. The base holds a supply of the edible coating. When the device is manipulated, the edible coating is applied to the confectionery product.

U.S. Pat. No. 5,976,590 to Coleman involves a screaming rocket pop which includes at least one inner telescoping housing within an outer housing. A lollipop can be secured to the at least one inner housing for consumption by a user. The at least one inner housing may have a lollipop stick retaining device extending from an upper end into the housing for securing the lollipop stick. The device includes a noisemaker therein which can be activated by blowing air through the housing.

U.S. Pat. No. 5,676,988 to Coleman describes a U.F.O. Pop consisting of a sucker-type candy with a candy stick inserted into an aperture at the top of a clear plastic upper housing. The clear plastic upper housing is connected to the plastic lower housing with a toy creature inside. The top of the plastic lower housing contains a circuit board, LEG bulbs, contact switch and a battery operated power supply. The outside of the plastic lower housing has a launch button on one side and a contact switch on the opposite side. The inside of the plastic lower housing contains a launch button, pin, push block with an anchored pivot point, release mechanism and a spring anchor containing a windup spring and a spinner shaft. The buttom of the plastic lower housing has winding locks and a spinner end. The flying disk is connected to the spinner end by placing the winding lock teeth over the winding locks at the bottom of the plastic lower housing. The flying disk is turned to windup for flight. It is now ready to launch. To launch the flying disk press the launch button. This causes the push block to engage the release mechanism. The release mechanism is pressed downward on the top of the spinner shaft to push the spinner and outward releasing the flying disk into the air.

U.S. Pat. No. 5,536,054 to Liaw discloses a lollypop holder designed to move a lollypop having a stick and a piece of hard candy at an end thereof in a wobbling motion. The lollypop holder comprises a generally tubular housing having an elongate chamber formed therein wherein the housing is adapted to be gripped within a person's hand. A power supply and a motor are located within the chamber of the housing. The motor is energized by the power supply and has a drive shaft which is rotatably driven. A switch is provided for selectively operating the motor. A gear train is driven by the drive shaft of the motor, the gear train also being located within the chamber of the housing. A lollypop receiving member has a first end portion which extends out of one end of the housing, the first end portion of the receiving member having an opening formed therein for receiving and securing the stick of the lollypop therein. The lollypop receiving member has a second end portion opposite to the first end portion which is manipulated by the gear train to produce a wobbling motion of the lollypop wherein the receiving member reciprocally swivels from side-to-side and moves axially in-and-out with respect to the housing.

U.S. Pat. No. 3,459,296 to Berg is directed to a container for a portion of an iced confection that can be exposed for eating. The container comprises an open-ended body portion conforming to the shape of the confection and a bottom having a hollow tubular handle extended through the opening in the bottom of the body portion.

U.S. Design Patent No. 353,251 to Beck illustrates an ornamental design for a safety candy holder.

Although known confection holders provide some advantages, they nonetheless present some drawbacks as well. For example, many known holders are relatively complicated, and can be awkward for children's small hands. Further, known holders are typically adapted to only one type of stick or confection. It can be seen from the foregoing that the need exists for a simple, inexpensive, versatile, and easily handled holder for frozen confections.

### SUMMARY

In accordance with the principles of the present invention, a frozen confection holding apparatus is adapted for use with frozen confections having either flat sticks or cylindrical sticks. The frozen confection holding apparatus includes an aperture assembly adapted and constructed to alternatively receive a flat stick of a frozen confection and a cylindrical stick of a frozen confection. A cylindrical gripping surface has an outer diameter slightly less than an inner diameter of a standard push-pop tube. In an embodiment, the frozen confection holding apparatus includes a first aperture having an inner volume conforming to the shape of a flat stick of a frozen confection, and a second aperture having an inner volume conforming to the shape of a cylindrical stick of a frozen confection. The frozen confection holder is movable between a first orientation in which the first aperture receives a flat stick of a frozen confection, and a second orientation in which the second aperture receives a cylindrical stick of a frozen confection.

The invention itself, however, both as to organization and method of operation, together with further objects and advantages thereof, may be best understood by reference to the following description taken in conjunction with the accompanying drawings.

### BRIEF DESCRIPTION OF THE DRAWINGS

FIG. 1 illustrates a frozen confection holder in accordance with the principles of the present invention.

FIG. 2 illustrates the FIG. 1 frozen confection holder in an open position.

FIG. 3 illustrates the FIG. 1 frozen confection holder used in conjunction with a confection having a flat stick.

FIG. 4 illustrates the FIG. 1 frozen confection holder used in conjunction with a confection having a cylindrical stick.

FIG. 5 illustrates a sectional view of the FIG. 4 frozen confection holder in an in-use position.

### DETAILED DESCRIPTION OF PREFERRED EMBODIMENTS

While this invention is susceptible of embodiment in many different forms, there is shown in the drawings, and will herein be described in detail, exemplary embodiments, with the understanding that the present disclosure is to be considered as illustrative of the principles of the invention and not intended to limit the invention to the exemplary embodiments shown and described.

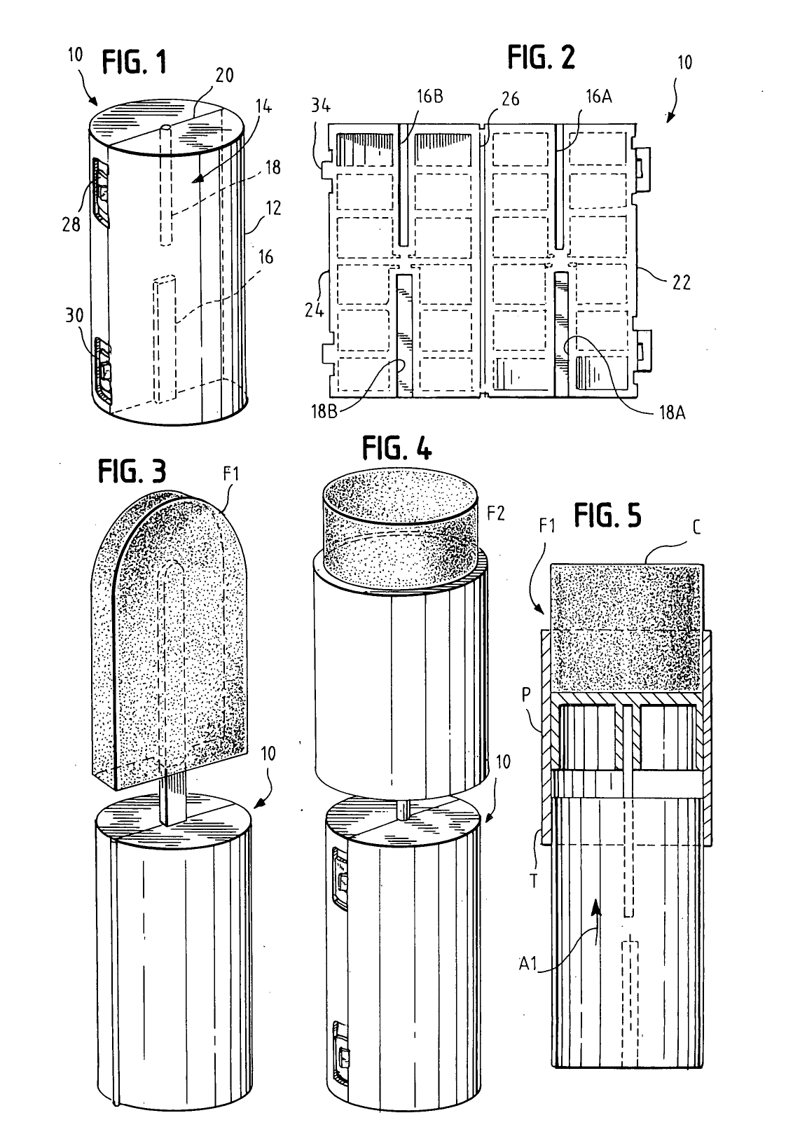

FIG. 1 illustrates frozen confection holding apparatus 10 in accordance with the principles of the present invention. The apparatus 10 is generally cylindrical, and includes a cylindrical gripping surface 12 sized to fit easily into the hand of a user. Although the frozen confection holder 10 can be made in any suitable size, it is contemplated that a cylinder having a height of approximately 3 inches and a diameter of approximately 11/16 inches will provide particular advantage. The frozen confection holding apparatus 10 is provided with an aperture assembly 14 including a first aperture 16 having an inner volume conforming to the shape of a flat stick of a frozen confection, and a second aperture 18 having an inner volume conforming to the shape of a cylindrical stick of a frozen confection. In order to fit standard frozen confection sticks in the U.S., it is contemplated that the first aperture 16 should have a dimension of approximately 1/16 inches X 7/16 inches, and that the second aperture 18 should have a diameter slightly less than approximately 3/16 inches. Each of the apertures 16, 18 should have a depth slightly less than 1½ inches. The first and second apertures 16, 18 are generally collinear with one another, and are positioned along the longitudinal axis of the frozen confection holding apparatus 10. The frozen confection holding apparatus 10 can be fabricated from any suitable material that provides insulation to the hand of the user while affording a good gripping surface. It is contemplated that a thermoplastic material such as HDPE will provide these qualities.

The frozen confection holding apparatus 10 is provided with a longitudinal divide 20. The longitudinal divide 20 separates the frozen confection holding apparatus 10 into first and second symmetrical halves 22, 24 joined by a hinge 26, as seen in FIG. 2, wherein the frozen confection holding apparatus 10 is in an open position. The first aperture 16 is formed by depressions 16A and 16B, while the second aperture 18 is formed by depressions 18A and 18B.

A pair of lock mechanisms 28, 30 are provided along the longitudinal divide 20. Each of the lock mechanisms includes a loop 32 on the first half 22 of the frozen confection holding apparatus 10, and a latch tab 34 on the second half 24 of the frozen confection holding apparatus 10. The latch tab 32 selectively locks into the loop 34 when the frozen confection holder 10 is in its closed position in FIG. 1.

The frozen confection holder 10 is movable between a first orientation in which the first aperture 16 receives a flat stick of a frozen confection F1, as shown in FIG. 3, and a second orientation in which the second aperture 18 receives a cylindrical stick of a frozen confection F2, as shown in FIG. 4.

As shown in FIG. 5, the frozen confection holder 10 has an outer diameter D that is slightly less than the inner diameter of a tube T of a standard push-pop F1. This allows the frozen confection holder 10 to move into the tube T in the direction of arrow A1, as the confection C is pushed up and exposed for eating. The frozen confection holder 10 acts as a stabilizing guide for the push cylinder P of the frozen confection F1, preventing the push cylinder P from becoming wedged and misaligned in the tube T. Further, the size and shape of the confection holder 10 facilitate ease of use by people with smaller hands, such as children, by providing improved leverage for operating a push pop, and by providing greater surface area for gripping.

It can be seen from the foregoing that the present invention provides advantages in a wide range of applications. For example, the frozen confection holder 10 can be provided with decorative patterns, advertising indicia, and the like, whether printed on the surface or molded into the frozen confection holder 10. While details of the invention are discussed herein with reference to some specific examples to which the principles of the present invention can be applied, the applicability of the invention to other devices and equivalent components thereof will become readily apparent to those of skill in the art. Accordingly, it is intended that all such alternatives, modifications, permutations, and variations to the exemplary embodiments can be made without departing from the scope and spirit of the present invention.

What is claimed is:

1. A frozen confection holding apparatus for use with frozen confections having either flat sticks or cylindrical sticks, the frozen confection holding apparatus comprising the following:
a first aperture having an inner volume conforming to the shape of a flat stick of a frozen confection; and
a second aperture having an inner volume conforming to the shape of a cylindrical stick of a frozen confection;
whereby the frozen confection holder is movable between a first orientation in which the first aperture receives a flat stick of a frozen confection, and a second orientation in which the second aperture receives a cylindrical stick of a frozen confection.

2. A frozen confection holding apparatus in accordance with claim 1, wherein the first and second apertures are generally collinear.

3. A frozen confection holding apparatus in accordance with claim 1, wherein the first and second apertures are positioned along a longitudinal axis of the frozen confection holding apparatus.

4. A frozen confection holding apparatus in accordance with claim 1, wherein the frozen confection holding apparatus is generally cylindrical.

5. A frozen confection holding apparatus in accordance with claim 4, wherein the frozen confection holding apparatus further comprises the following:
a longitudinal divide separating the holder into first and second symmetrical halves; and
a hinge element movably connecting the first half to the second half;
whereby the frozen confection holding apparatus is movable between an open position in which a frozen confection stick can be inserted into or removed from one of the apertures, and a closed position in which the inserted frozen confection stick is held securely in the frozen confection holding apparatus.

6. A frozen confection holding apparatus in accordance with claim 5, further comprising at least one lock mechanism adjacent to the longitudinal divide, the lock mechanism being adapted and constructed to lock the frozen confection holder in its closed position.

7. A frozen confection holding apparatus in accordance with claim 6, wherein each of the at least one lock mechanisms comprises a loop on the first half of the frozen confection holding apparatus, and a latch tab on the second half of the frozen confection holding apparatus, the latch tab being adapted and constructed to selectively lock into the loop when the frozen confection holder is in its closed position.

8. A frozen confection holding apparatus in accordance with claim 6, wherein each of the at least one lock mechanisms comprises a pair of lock mechanisms.

9. A frozen confection holding apparatus in accordance with claim 4, wherein the frozen confection holding apparatus has an outer diameter slightly less than an inner diameter of a standard push-pop tube.

10. A frozen confection holding apparatus in accordance with claim 1, wherein the frozen confection holding apparatus is constructed from a thermoplastic material.

11. A frozen confection holding apparatus for use with frozen confections having either flat sticks or cylindrical sticks, the frozen confection holding apparatus comprising the following:
an aperture assembly adapted and constructed to alternatively receive a flat stick of a frozen confection and a cylindrical stick of a frozen confection; and
a cylindrical gripping surface having an outer diameter slightly less than an inner diameter of a standard push-pop tube.

12. A frozen confection holding apparatus in accordance with claim 11, wherein the aperture assembly comprises the following:
a first aperture having an inner volume conforming to the shape of a flat stick of a frozen confection; and
a second aperture having an inner volume conforming to the shape of a cylindrical stick of a frozen confection;
whereby the frozen confection holder is movable between a first orientation in which the first aperture receives a flat stick of a frozen confection, and a second orientation in which the second aperture receives a cylindrical stick of a frozen confection.

13. A frozen confection holding apparatus in accordance with claim 12, wherein the first and second apertures are generally collinear.

14. A frozen confection holding apparatus in accordance with claim 13, wherein the first and second apertures are positioned along a longitudinal axis of the frozen confection holding apparatus.

15. A frozen confection holding apparatus in accordance with claim 11, wherein the frozen confection holding apparatus further comprises the following:
a longitudinal divide separating the holder into first and second symmetrical halves; and
a hinge element movably connecting the first half to the second half;
whereby the frozen confection holding apparatus is movable between an open position in which a frozen confection stick can be inserted into or removed from one of the apertures, and a closed position in which the inserted frozen confection stick is held securely in the frozen confection holding apparatus.

16. A frozen confection holding apparatus in accordance with claim 15, further comprising at least one lock mechanism adjacent to the longitudinal divide, the lock mechanism being adapted and constructed to lock the frozen confection holder in its closed position.

17. A frozen confection holding apparatus in accordance with claim 16, wherein each of the at least one lock mechanisms comprises a loop on the first half of the frozen confection holding apparatus, and a latch tab on the second half of the frozen confection holding apparatus, the latch tab being adapted and constructed to selectively lock into the loop when the frozen confection holder is in its closed position.

18. A frozen confection holding apparatus in accordance with claim 16, wherein each of the at least one lock mechanisms comprises a pair of lock mechanisms.

19. A frozen confection holding apparatus in accordance with claim 11, wherein the frozen confection holding apparatus is constructed from a thermoplastic material.
